(19) United States
(12) Patent Application Publication
(10) Pub. No.: US 2020/0199006 A1
(43) Pub. Date: Jun. 25, 2020

(54) PROCESS AND APPARATUS FOR FORMING CURVED GLASS VIA DIFFERENTIAL HEATING OF GLASS SHEET

(71) Applicant: CORNING INCORPORATED, CORNING, NY (US)

(72) Inventors: Anurag Jain, Painted Post, NY (US); Nikolaos Pantelis Kladias, Horseheads, NY (US); Zheming Zheng, Horseheads, NY (US)

(21) Appl. No.: 16/608,676

(22) PCT Filed: Apr. 27, 2018
(86) PCT No.: PCT/US2018/029687

§ 371 Date: Oct. 25, 2019

Related U.S. Application Data
(60) Provisional application No. 62/490,875, filed on Apr. 27, 2017.

(51) Int. Cl. C03B 23/025; C03B 23/023; C03B 23/03; C03B 23/035

(52) U.S. Cl. CPC C03B 23/0258; C03B 23/0235; C03B 29/025; C03B 23/0352; C03B 23/0307

(57) ABSTRACT

A process and system for forming a curved glass article from a sheet of glass material is provided. The process and system includes supporting a glass sheet on a shaping frame and then heating the sheet of glass material while supported by the shaping frame such that the central region of the sheet of glass material deforms into an open central cavity of the bending frame. The process and/or system are configured such that an aspect of the heating experienced by an outer region of the sheet of glass material is less than an aspect of the heating experienced by the central region of the sheet of glass material. The aspect of heating may be the average temperature, the maximum temperature and/or the heating rate, which Applicant believes may reduce certain defects during the shaping operation.

### CROSS-REFERENCE TO RELATED APPLICATIONS

This application claims the benefit of priority under 35 U.S.C. § 119 of U.S. Provisional Application Ser. No. 62/490,875 filed on Apr. 27, 2017, the content of which is relied upon and incorporated herein by reference in its entirety.

### BACKGROUND

The disclosure relates generally to forming a curved glass article, and specifically to processes forming curved glass articles via a shaping frame utilizing differential heating. Curved glass sheets or articles find use in many applications, particularly as for vehicle or automotive window glass. Typically, curved glass sheets for such applications have been formed from relatively thick sheets of glass material. Applicant has found that traditional shaping processes may produce a variety of undesirable characteristics (e.g., edge wrinkling, over-sagging of glass at the edges, etc.) in the curved glass sheet, the severity of which appears to increase as glass sheet thickness decreases.

### SUMMARY

One embodiment of the disclosure relates to a process for forming a curved glass article from a sheet of glass material. The process includes placing an outer region of the sheet of glass material into contact with a support surface of a shaping frame, the shaping frame defining an open central cavity surrounded at least in part by the support surface. The process includes supporting the sheet of glass material with the shaping frame via the contact between the sheet of glass material and the support surface such that a central region of the sheet of glass material is suspended over the open central cavity of the shaping frame. The process includes heating the sheet of glass material while supported by the shaping frame such that the central region of the sheet of glass material deforms into the open central cavity in a direction away from the support surface of the shaping frame. An aspect of the heating experienced by the outer region of the sheet of glass material is less than an aspect of the heating experienced by the central region of the sheet of glass material. The process includes cooling the sheet of glass material following heating to form the curved glass article from the sheet of glass material.

An additional embodiment of the disclosure relates to a system for forming a curved glass article from a sheet of glass material. The system includes a support ring. The support ring includes a radially inward facing inner surface defining an open central cavity, a radially outward facing surface, an upper surface surrounding the open central cavity at an upper end of the support ring, and a bottom surface opposite the upper surface. The sheet of glass material is supported from the upper surface of the support ring with a central region of the sheet of glass material suspended over the open central cavity of the support ring. The system includes a heating station having a heating chamber. The support ring is located within the heating chamber, and the heating station is configured to heat the support ring and the sheet of glass material such that the central region of the sheet of glass material sags downward into the open central cavity under gravity. The support ring is configured to conduct heat away from the sheet of glass material through the contact at the upper surface with the sheet of glass material such that an aspect of heating experienced by the portion of the sheet of glass material in contact with the upper surface of the support ring is less than an aspect of the heating experienced by the central region of the sheet of glass material.

Additional features and advantages will be set forth in the detailed description that follows, and, in part, will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding and are incorporated in and constitute a part of this specification. The drawings illustrate one or more embodiment(s), and together with the description serve to explain principles and the operation of the various embodiments.

### BRIEF DESCRIPTION OF THE DRAWINGS

FIG. 1 is a cross-sectional view showing glass sheets supported by a high thermal mass bending ring, according to an exemplary embodiment.

FIG. 2 is a cross-sectional view showing glass sheets supported by a high thermal bending ring within a heating station, according to an exemplary embodiment.

FIG. 3 is a detailed view of the contact location between a glass sheet and a high thermal mass bending ring, according to an exemplary embodiment

FIG. 4 is a perspective view of a high thermal mass bending ring, according to an exemplary embodiment.

FIG. 5 is a perspective view of a high thermal mass bending ring, according to an exemplary embodiment.

### DETAILED DESCRIPTION

Referring generally to the figures, various embodiments of a system and method for shaping, bending or sagging glass material are shown and described. In general, the system and method discussed herein provides for differential heating between the center of a glass sheet and a supported, outer portion of the glass sheet. As will be discussed in detail herein, Applicant believes this differential heating will improve the quality of the shaped or bent, curved glass article.

In some glass shaping methods one or more glass sheet is supported on a bending ring, and the glass sheet is heated to near its softening temperature. A curved shape is formed in the glass sheet, as gravity pulls the center of the softening glass downward into the bending ring. Applicant has found that certain defects, e.g., edge wrinkling and sharp sagging near the edge of the glass sheet (typically referred to in the industry as “bathtub defect”), can be a problem during gravity sagging of large sheets of thin glass (e.g., thin, chemical strengthened glass such as Gorilla Glass from Corning Incorporated used for a variety of applications such as vehicle or automotive windows). Applicant has found that defects, such as edge wrinkling and bathtub defect, can be reduced by decreasing an aspect of heating (e.g., temperature, heating rate, etc.) experienced by the outer portion of the glass sheet as compared to the central portion of the glass sheet.

Specifically, Applicant has performed studies related to the cause of the bathtub defect which show that the presence of membrane stresses during bending that are highest at the center of the glass sheet and decrease to zero at the edges. These membrane stresses stiffen the sheet in the middle, resulting in under-sagging at the center relative to the edges. The edges of the glass sheet on the other hand over-sag due to low membrane stresses under gravitational loads. In general, Applicant has found that the bathtub defect may be addressed by differential heating of the glass sheet with higher center region temperatures and low edge region temperatures resulting in an overall thermal gradient from center to edge.

Edge wrinkling (also referred to in the industry as buckling) is a mechanical instability indicated by a sudden change of structure due to bifurcation associated with loss of structural stability. Wrinkling is triggered by compressive stresses reaching above a critical threshold value which is mainly dependent on glass edge stiffness which in-turn depends on glass plate thickness as well as modulus and viscosity of glass at that temperature. Applicant has utilized numerical modeling to show that wrinkling can be mitigated by increasing the edge stiffness by establishing a local thermal gradient near the glass edge, with the glass edge region being locally colder as compared to the center of the glass sheet. This local gradient at the glass edge effectively increases the glass viscosity and modulus of the glass at the edge, and thereby increases its bending stiffness under edge compressive stresses. This in turn decreases the potential for the formation of edge wrinkles.

While a variety of approaches and processes for generating the different temperatures between the edge and the center of the glass sheet may be used, in particular embodiments discussed herein the temperature gradient is generated by supporting the glass sheet on a high thermal mass bending ring. In contrast to conventional bending rings that are generally intentionally designed to have low thermal mass (e.g., are small, lightweight, made from a low thermal conductivity material, have a variety of through holes, etc.), the bending rings discussed herein are designed to have a relatively large thermal mass. Due to the contact with the edge of the glass sheet, the high thermal mass bending ring conducts heat away from the area near the edge of the glass sheet, resulting in a lower glass temperature at the edge compared to the center. As noted above, this temperature gradient is believed to decrease both edge wrinkling and bathtub defects.

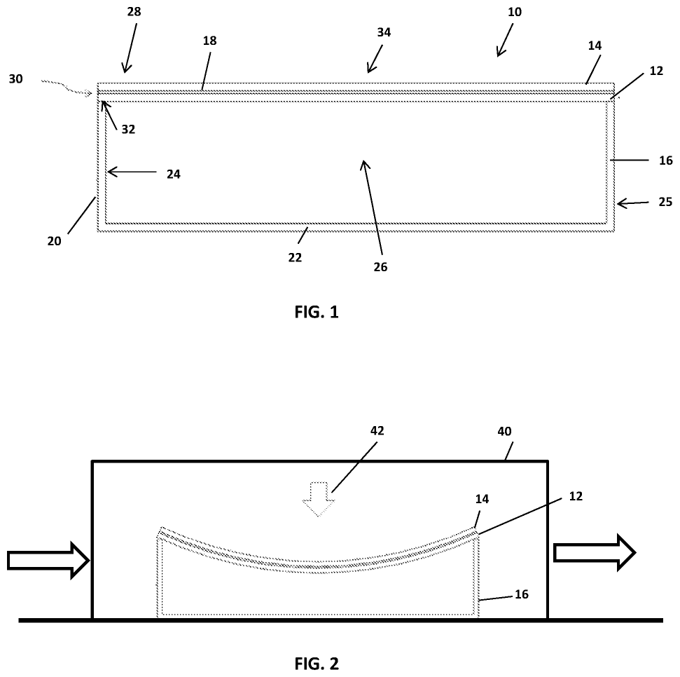

Referring to FIG. 1 and FIG. 2, a system and process for forming a curved glass article is shown according to an exemplary embodiment. In general, system 10 includes one or more sheet of glass material, shown as a pair of glass sheets 12 and 14, supported by a shaping frame, shown as bending ring 16. In one embodiment, bending ring 16 may be used for shaping glass sheets 12 and 14 in a co-sagging arrangement, as shown in FIG. 1, and in such embodiments, a separation material 18 may be utilized between glass sheets 12 and 14 to prevent them from bonding together. In other embodiments, a single glass sheet, such as glass sheet 12, may be supported by bending ring 16, and shaped into a curved shape as discussed herein. Further it should be understood that bending ring 16 may have a wide variety of shapes selected based on the shape of the glass sheet to be supported, and use of the term ring does not necessarily denote a circular shape.

As shown in FIG. 1, bending ring 16 includes a support wall, shown as sidewall 20, and a bottom wall 22. Sidewall 20 extends upward and away from bottom wall 22. The radially inward facing surface 24 of sidewall 20 defines an open central region or cavity 26, and an upward facing surface of bottom wall 22 defines the lower end of cavity 26. A radially outward facing surface 25 is opposite of inward facing surface 24.

To begin the shaping process, an outer region 28 of glass sheet 12 adjacent the outer perimeter edge 30 of the glass sheet is placed into contact with a support surface, shown as upward facing surface 32, of bending ring 16. In this arrangement, glass sheet 12 is supported by the contact between upward facing surface 32 and glass sheet 12 such that a central region 34 of glass sheet 12 is supported over central cavity 26.

Next, bending ring 16 and supported glass sheets 12 and/or 14 are moved into a heating station 40, such as an oven or serial indexing lehr. Within heating station 40, glass sheets 12 and/or 14 and bending ring 16 are heated (e.g., to near or at the softening temperature of the glass material of glass sheets 12 and 14) while glass sheets 12 and 14 are supported on bending ring 16. As glass sheets 12 and 14 are heated, a shaping force, such as the downward force 42, causes central region 34 of glass sheets 12 and 14 to deform or sag downward into central cavity 26 of bending ring 16. In specific embodiments, the downward force is provided by gravity. In some embodiments, the downward force may be provided via air pressure (e.g., creating a vacuum on the convex side of glass sheets 12 and 14, blowing air on the concave side of glass sheets 14, via press or other contact based molding machine, etc.) Regardless of the source of the deforming force, this procedure results in glass sheets having a curved shape as shown in FIG. 2.

After a period of time determined to allow glass sheets 12 and 14 to develop the desired curved shape, bending ring 16 along with the supported glass sheets 12 and/or 14 are then cooled to room temperature. Thus, the shaped, deformed or curved glass sheets 12 and 14 are allowed to cool, fixing glass sheets 12 and 14 into the curved shape created within heating station 40. Once cooled, curved glass sheets 12 and 14 are removed from bending ring 16 and another set of flat glass sheets are placed onto bending ring 16, and the shaping process is repeated.

In conventional processes, glass sheets and the supporting, bending ring are heated at generally the same rate and to the same temperatures during the heating stage of the shaping process. As noted above, Applicant has determined that by differentially heating outer region 28 and central region 34 of glass sheets 12 and 14, various defects, such as bathtub defect and edge wrinkle, can be reduced or eliminated. Thus, in general, system 10 discussed herein is configured such that at least one aspect of the heating experienced by outer region 28 of glass sheet 12 and/or 14 is less than at least one aspect of the heating experienced by central region 34 of glass sheet 12 and/or 14.

In specific embodiments, system 10 is configured such that the average temperature experienced by outer region 28 of glass sheet 12 and/or 14 during heating within heating station 40 is less than the average temperature experienced by central region 34 of glass sheet 12 and/or 14 during heating within heating station 40. In a more specific embodiment, system 10 is configured such that the average temperature experienced by outer region 28 of glass sheet 12 and/or 14 during heating within heating station 40 is at least 30 degrees C. less than the average temperature experienced by central region 34 of glass sheet 12 and/or 14 during heating within heating station 40. In an even more specific embodiment, system 10 is configured such that the average temperature experienced by outer region 28 of glass sheet 12 and/or 14 during heating within heating station 40 is 30 to 40 degrees C. less than the average temperature experienced by central region 34 of glass sheet 12 and/or 14 during heating within heating station 40.

In another specific embodiment, system 10 is configured such that the heating rate experienced by outer region 28 of glass sheet 12 and/or 14 during heating within heating station 40 is less than the heating rate experienced by central region 34 of glass sheet 12 and/or 14 during heating within heating station 40. In another specific embodiment, system 10 is configured such that the maximum temperature experienced by outer region 28 of glass sheet 12 and/or 14 during heating within heating station 40 is less than the maximum temperature experienced by central region 34 of glass sheet 12 and/or 14 during heating within heating station 40.

While there are a variety of potential ways to create these differential heating aspects, in particular embodiments discussed herein, bending ring 16 is configured such that the differential heating between outer region 28 and central region 34 of the glass sheet(s) is created by conducting heat from outer region 28 into bending ring 16 through the contact at upper surface 32. In general, this heat conduction-based temperature differential may be provided by designing bending ring 16 to have a high thermal mass. In this design, bending ring 16 acts as a heat sink, slowing the heating rate of the areas of glass sheets 12 and/or 14 close to upper surface 32 compared to the heating rate that central area 34 experiences within heating station 40. As will be generally understood, the thermal mass and heat transfer characteristics of bending ring 16 can be designed to account for a variety of application specific factors, such as the thickness of the glass sheets, the glass material being shaped, the desired shape characteristics, the heating profile of the heating station, etc. In specific embodiments, due to increased susceptibility to defect formation during shaping, thin glass sheets (such as glass sheets having an average thickness less than 1.0 mm) bending using conventional bending ring designs is believed to produce unsatisfactory results, and Applicant believes that the high thermal mass designs for bending ring 16 discussed herein may address such defects and be particularly suitable for forming curved, thin glass sheets.

In specific embodiments, high thermal mass bending ring 16 is formed from a material having a low thermal diffusivity. In one specific embodiment, bending ring is formed from a material having a thermal diffusivity of less than 2×10⁻⁵ m²/s. In another specific embodiment, bending ring is formed from a material having a thermal diffusivity of less than 4×10⁻⁶ m²/s. In specific embodiments, bending ring 16 is formed from one or more of the materials listed in Table 1 below.²

TABLE 1

| | | | Thermal | |
|---|---|---|---|---|
| | Density | Specific heat | Conductivity (W/m | Thermal Diffusivity |
| Material | (Kg/m³) | (J/Kg ° C.) | ° C.) | (m²/s) |
| SS 304 | 8027 | 502 | 16.26 | 4.03519E−06 |
| Iron Cast | 7920 | 456 | 55 | 1.5229E−05 |
| Incolloy 800 | 7950 | 544 | 14.8 | 3.42212E−06 |
| Nickel (80% Ni 20% Cr) | 8314 | 444 | 12.6 | 3.41332E−06 |
| Steel, Nickel Ni 40% | 8618 | 460 | 10 | 2.52253E−06 |
| Inconel | 8440 | 502 | 15.3 | 3.61115E−06 |

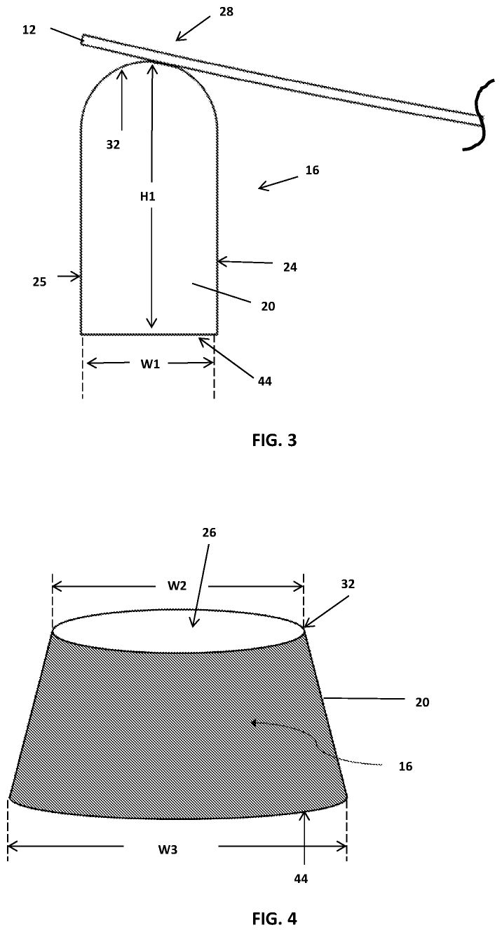

Instead of or in addition to utilizing low thermal diffusivity material, bending ring 16 may be shaped or structured in one or more ways to improve heat conduction away from outer region 28 of glass sheet 12 and/or 14. A detailed view of contact between upper surface 32 of bending ring 16 and glass sheet 12 is shown in FIG. 3. In the embodiment shown in FIG. 3, sidewall 20 of bending ring 16 is shaped to be substantially larger than conventional bending rings, which tend to be designed to be small and lightweight. This increased size of bending ring 16 results in bending ring 16 having a larger thermal mass, which in turn facilitates creation of one or more of the temperature differentials during heating as discussed above.

As shown in FIG. 3, bending ring 16 has a height, H1, measured between upper surface 32 and the lower surface 44 of bending ring 16 (which may be a lower surface of sidewall 20 or a lower surface of bottom wall 22). In general, H1 is greater than 20 mm, and specifically may be greater than 30 mm. Thus, the height of sidewall 20 of bending ring 16 is larger than the height of typical bending rings which typically have a height between 10 mm and 20 mm. In a specific embodiment, H1, represents the average height of bending ring 16 measured around the full circumferential length of upper surface 32.

As shown in FIG. 3, bending ring 16 has a width, W1, measured between inward facing surface 24 and outward facing surface 25 of bending ring 16 through the vertical center point of sidewall 20. In general, W1 is greater than 3 mm, and specifically may be greater than 4 mm. Thus, the width of sidewall 20 of bending ring 16 is larger than the width of typical bending rings which typically have a width between 2 mm and 3 mm. In a specific embodiment, W1 represents the average width of sidewall 20 measured around the full perimeter of sidewall 20.

In addition to increasing the material used to form bending ring 16, Applicant believes that the shape and/or structure of bending ring 16 may be configured to improve heat conduction. Referring to the embodiment of FIG. 4, bending ring 16 may be formed from a solid contiguous piece of metal material. In contrast to some conventional bending rings that include holes formed through the ring sidewall, utilizing a solid, heat conducting material for bending ring 16 increases the thermal mass of bending ring 16. Further, the solid structure of sidewall 20 provides a conductive path from support surface 32 to bottom wall 22 facilitating conduction of heat to the full mass of bending ring 16.

Further, as shown in FIG. 4, bending ring 16 may be formed to have a tapered shape. In this arrangement the average outer width, W2, measured at upper surface 32, is less than the average outer width, W3, measured across bottom surface 44. As can be seen, this arrangement, allows bending ring 16 to support a glass sheet having the smaller dimensions set by W2, while adding extra thermal mass to the bottom of bending ring 16.

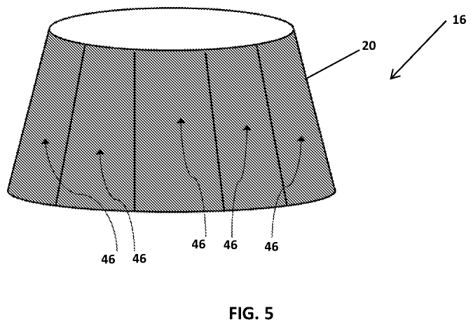

Referring to FIG. 5, in another embodiment, sidewall 20 of bending ring 16 may include one or more removable panels, shown as panels 46. In the embodiment shown, a plurality of removable panels 46 form the entire sidewall 20. In general, the removable panels 46 enable preferential cooling at desired glass locations. Specifically, the design shown in FIG. 5 allows for the introduction of different thermal gradients at locations of the glass sheet which have the highest tendency to wrinkle.

In various embodiments, glass sheets 12 and/or 14 following curve formation may be utilized in a variety of applications. In specific embodiments, the curved glass sheets produced via the systems and methods discussed herein are used to form vehicle (e.g., automotive) windows. In some such embodiments, curved glass sheets 12 and 14 are bonded together to form a glass laminate article. In some such embodiments, the systems and methods discussed herein are utilized to form a single layer, curved glass sheet that may be used as vehicle (e.g., automotive) windows. In specific embodiments, the system and method discussed herein are particularly configured to reduce defects when forming, thin, curved glass sheets. In such embodiments, the thickness of glass sheet 12 and/or 14 is less than 1 mm, specifically is 0.05 mm to 1.0 mm, and more specifically is 0.3 mm to 0.8 mm.

Glass sheets 12 and/or 14 can be formed from a variety of materials. In specific embodiments, glass sheets 12 and/or 14 are formed from a chemically strengthened alkali aluminosilicate glass composition or an alkali aluminoborosilicate glass composition, and in other embodiments, glass sheets 12 and/or 14 are formed from a soda lime glass (SLG) composition.

In specific embodiments, glass sheets 12 and/or 14 are formed from a chemically strengthened material, such as an alkali aluminosilicate glass material or an alkali aluminoborosilicate glass composition, having a chemically strengthened compression layer having a depth of compression (DOC) in a range from about 30 μm to about 90 μm, and a compressive stress on at least one of the sheet's major surfaces of between 300 MPa to 1000 MPa. In some embodiments, the chemically strengthened glass is strengthened through ion exchange

### Examples of Glass Materials and Properties

In various embodiments, glass sheets 12 and/or 14 may be formed from any of a variety of strengthened glass compositions. Examples of glasses that may be used for glass sheets 12 and/or 14 described herein may include alkali aluminosilicate glass compositions or alkali aluminoborosilicate glass compositions, though other glass compositions are contemplated. Such glass compositions may be characterized as ion exchangeable. As used herein, “ion exchangeable” means that the layer comprising the composition is capable of exchanging cations located at or near the surface of the glass layer with cations of the same valence that are either larger or smaller in size. In one exemplary embodiment, the glass composition of glass sheets 12 and/or 14 comprises SiO₂, B₂O₃ and Na₂O, where (SiO₂+B₂O₃)≥66 mol. %, and Na₂O≥9 mol. %. Suitable glass compositions for glass sheets 12 and/or 14, in some embodiments, further comprise at least one of K₂O, MgO, and CaO. In a particular embodiment, the glass compositions used in glass sheets 12 and/or 14 can comprise 61-75 mol. % SiO₂; 7-15 mol. % Al₂O₃; 0-12 mol. % B₂O₃; 9-21 mol. % Na₂O; 0-4 mol. % K₂O; 0-7 mol. % MgO; and 0-3 mol. % CaO.

A further example of glass composition suitable for glass sheets 12 and/or 14 comprises: 60-70 mol. % SiO₂; 6-14 mol. % Al₂O₃; 0-15 mol. % B₂O₃; 0-15 mol. % Li₂O; 0-20 mol. % Na₂O; 0-10 mol. % K₂O; 0-8 mol. % MgO; 0-10 mol. % CaO; 0-5 mol. % ZrO₂; 0-1 mol. % SnO₂; 0-1 mol. % CeO₂; less than 50 ppm As₂O₃; and less than 50 ppm 5b₂O₃; where 12 mol. %≤(Li₂O+Na₂O+K₂O)≤20 mol. % and 0 mol. % (MgO+CaO)≤10 mol. %.

A still further example of glass composition suitable for glass sheets 12 and/or 14 comprises: 63.5-66.5 mol. % SiO₂; 8-12 mol. % Al₂O₃; 0-3 mol. % B₂O₃; 0-5 mol. % Li₂O; 8-18 mol. % Na₂O; 0-5 mol. % K₂O; 1-7 mol. % MgO; 0-2.5 mol. % CaO; 0-3 mol. % ZrO₂; 0.05-0.25 mol. % SnO₂; 0.05-0.5 mol. % CeO₂; less than 50 ppm As₂O₃; and less than 50 ppm Sb₂O₃; where 14 mol. %≤(Li₂O+Na₂O+K₂O)≤18 mol. % and 2 mol. %≤(MgO+CaO)≤7 mol. %.

In a particular embodiment, an alkali aluminosilicate glass composition suitable for glass sheets 12 and/or 14 comprises alumina, at least one alkali metal and, in some embodiments, greater than 50 mol. % SiO₂, in other embodiments at least 58 mol. % SiO₂, and in still other embodiments at least 60 mol. % SiO₂, wherein the ratio ((Al₂O₃+B₂O₃)/Σmodifiers)>1, where in the ratio the components are expressed in mol. % and the modifiers are alkali metal oxides. This glass composition, in particular embodiments, comprises: 58-72 mol. % SiO₂; 9-17 mol. % Al₂O₃; 2-12 mol. % B₂O₃; 8-16 mol. % Na₂O; and 0-4 mol. % K₂O, wherein the ratio ((Al₂O₃+B₂O₃)/Σmodifiers)>1.

In still another embodiment, glass sheets 12 and/or 14 may include an alkali aluminosilicate glass composition comprising: 64-68 mol. % SiO₂; 12-16 mol. % Na₂O; 8-12 mol. % Al₂O₃; 0-3 mol. % B₂O₃; 2-5 mol. % K₂O; 4-6 mol. % MgO; and 0-5 mol. % CaO, wherein: 66 mol. %≤SiO₂+B₂O₃+CaO≤69 mol. %; Na₂O+K₂O+B₂O₃+MgO+CaO+SrO>10 mol. %; 5 mol. %≤MgO+CaO+SrO≤8 mol. %; (Na₂O+B₂O₃)—Al₂O₃≤2 mol. %; 2 mol. %≤Na₂O—Al₂O₃≤6 mol. %; and 4 mol. %≤(Na₂O+K₂O)—Al₂O₃≤10 mol. %.

In an alternative embodiment, glass sheets 12 and/or 14 may comprise an alkali aluminosilicate glass composition comprising: 2 mol % or more of Al₂O₃ and/or ZrO₂, or 4 mol % or more of Al₂O₃ and/or ZrO₂. In one or more embodiments, glass sheets 12 and/or 14 comprises a glass composition comprising SiO₂ in an amount in the range from about 67 mol % to about 80 mol %, Al₂O₃ in an amount in a range from about 5 mol % to about 11 mol %, an amount of alkali metal oxides (R₂O) in an amount greater than about 5 mol % (e.g., in a range from about 5 mol % to about 27 mol %). In one or more embodiments, the amount of R₂O comprises Li₂O in an amount in a range from about 0.25 mol % to about 4 mol %, and K₂O in an amount equal to or less than 3 mol %. In one or more embodiments, the glass composition includes a non-zero amount of MgO, and a non-zero amount of ZnO.

In other embodiments, glass sheets 12 and/or 14 are formed from a composition that exhibits SiO₂ in an amount in the range from about 67 mol % to about 80 mol %, Al₂O₃ in an amount in the range from about 5 mol % to about 11 mol %, an amount of alkali metal oxides (R₂O) in an amount greater than about 5 mol % (e.g., in a range from about 5 mol % to about 27 mol %), wherein the glass composition is substantially free of Li₂O, and a non-zero amount of MgO; and a non-zero amount of ZnO.

In other embodiments, glass sheets 12 and/or 14 are an aluminosilicate glass article comprising: a glass composition comprising SiO₂ in an amount of about 67 mol % or greater; and a sag temperature in a range from about 600° C. to about 710° C. In other embodiments, glass sheets 12 and/or 14 are formed from an aluminosilicate glass article comprising: a glass composition comprising SiO₂ in an amount of about 68 mol % or greater; and a sag temperature in a range from about 600° C. to about 710° C. (as defined herein).

In some embodiments, glass sheets 12 and/or 14 are formed from different glass materials from each other that differs in any one or more of composition, thickness, strengthening level, and forming method (e.g., float formed as opposed to fusion formed). In one or more embodiments, glass sheets 12 and/or 14 described has a sag temperature of about 710° C., or less or about 700° C. or less. In one or more embodiments, one of the glass sheets 12 and 14 is a soda lime glass sheet, and the other of the glass sheets 12 and 14 is any one of the non-soda lime glass materials discussed herein. In one or more embodiments, glass sheets 12 and/or 14 comprises a glass composition comprising SiO₂ in an amount in the range from about 68 mol % to about 80 mol %, Al₂O₃ in an amount in a range from about 7 mol % to about 15 mol %, B₂O₃ in an amount in a range from about 0.9 mol % to about 15 mol %; a non-zero amount of P₂O₅ up to and including about 7.5 mol %, Li₂O in an amount in a range from about 0.5 mol % to about 12 mol %, and Na₂O in an amount in a range from about 6 mol % to about 15 mol %.

In some embodiments, the glass composition of glass sheets 12 and/or 14 may include an oxide that imparts a color or tint to the glass articles. In some embodiments, the glass composition of glass sheets 12 and/or 14 includes an oxide that prevents discoloration of the glass article when the glass article is exposed to ultraviolet radiation. Examples of such oxides include, without limitation oxides of: Ti, V, Cr, Mn, Fe, Co, Ni, Cu, Ce, W, and Mo.

Glass sheets 12 and/or 14 may have a refractive index in the range from about 1.45 to about 1.55. As used herein, the refractive index values are with respect to a wavelength of 550 nm. Glass sheets 12 and/or 14 may be characterized by the manner in which it is formed. For instance, glass sheets 12 and/or 14 may be characterized as float-formable (i.e., formed by a float process), down-drawable and, in particular, fusion-formable or slot-drawable (i.e., formed by a down draw process such as a fusion draw process or a slot draw process). In one or more embodiments, glass sheets 12 and/or 14 described herein may exhibit an amorphous microstructure and may be substantially free of crystals or crystallites. In other words, in such embodiments, the glass articles exclude glass-ceramic materials.

In one or more embodiments, glass sheets 12 and/or 14 exhibits an average total solar transmittance of about 88% or less, over a wavelength range from about 300 nm to about 2500 nm, when glass sheets 12 and/or 14 has a thickness of 0.7 mm. For example, glass sheets 12 and/or 14 exhibits an average total solar transmittance in a range from about 60% to about 88%, from about 62% to about 88%, from about 64% to about 88%, from about 65% to about 88%, from about 66% to about 88%, from about 68% to about 88%, from about 70% to about 88%, from about 72% to about 88%, from about 60% to about 86%, from about 60% to about 85%, from about 60% to about 84%, from about 60% to about 82%, from about 60% to about 80%, from about 60% to about 78%, from about 60% to about 76%, from about 60% to about 75%, from about 60% to about 74%, or from about 60% to about 72%.

In one or more embodiments, glass sheets 12 and/or 14 exhibit an average transmittance in the range from about 75% to about 85%, at a thickness of 0.7 mm or 1 mm, over a wavelength range from about 380 nm to about 780 nm. In some embodiments, the average transmittance at this thickness and over this wavelength range may be in a range from about 75% to about 84%, from about 75% to about 83%, from about 75% to about 82%, from about 75% to about 81%, from about 75% to about 80%, from about 76% to about 85%, from about 77% to about 85%, from about 78% to about 85%, from about 79% to about 85%, or from about 80% to about 85%. In one or more embodiments, glass sheets 12 and/or 14 exhibits Tᵤᵥ₋₃₈₀ or Tᵤᵥ₋₄₀₀ of 50% or less (e.g., 49% or less, 48% or less, 45% or less, 40% or less, 30% or less, 25% or less, 23% or less, 20% or less, or 15% or less), at a thickness of 0.7 mm or 1 mm, over a wavelength range from about 300 nm to about 400 nm.

In one or more embodiments, glass sheets 12 and/or 14 may be strengthened to include compressive stress that extends from a surface to a depth of compression (DOC). The compressive stress regions are balanced by a central portion exhibiting a tensile stress. At the DOC, the stress crosses from a positive (compressive) stress to a negative (tensile) stress.

In one or more embodiments, glass sheets 12 and/or 14 may be strengthened mechanically by utilizing a mismatch of the coefficient of thermal expansion between portions of the article to create a compressive stress region and a central region exhibiting a tensile stress. In some embodiments, the glass article may be strengthened thermally by heating the glass to a temperature below the glass transition point and then rapidly quenching.

In one or more embodiments, glass sheets 12 and/or 14 may be chemically strengthening by ion exchange. In the ion exchange process, ions at or near the surface of glass sheets 12 and/or 14 are replaced by—or exchanged with—larger ions having the same valence or oxidation state. In those embodiments in which glass sheets 12 and/or 14 comprises an alkali aluminosilicate glass, ions in the surface layer of the article and the larger ions are monovalent alkali metal cations, such as Li⁺, Na⁺, K⁺, Rb⁺, and Cs⁺. Alternatively, monovalent cations in the surface layer may be replaced with monovalent cations other than alkali metal cations, such as Ag⁺ or the like. In such embodiments, the monovalent ions (or cations) exchanged into glass sheets 12 and/or 14 generate a stress.

Glass sheets 12 and/or 14 can be used for a variety of different applications, devices, uses, etc. In various embodiments, glass sheets 12 and/or 14 may form the sidelights, windshields, rear windows, windows, rearview mirrors, and sunroofs of a vehicle. As used herein, vehicle includes automobiles, rolling stock, locomotive, boats, ships, and airplanes, helicopters, drones, space craft and the like. In other embodiments, glass sheets 12 and/or 14 may be used in a variety of other applications where thin curved glass sheets may be advantageous. For example, glass sheets 12 and/or 14 may be used as architectural glass, building glass, etc.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

Aspect (1) of the present disclosure pertains to a process for forming a curved glass article from a sheet of glass material, the process comprising: placing an outer region of the sheet of glass material into contact with a support surface of a shaping frame, the shaping frame defining an open central cavity surrounded at least in part by the support surface; supporting the sheet of glass material with the shaping frame via the contact between the sheet of glass material and the support surface such that a central region of the sheet of glass material is suspended over the open central cavity of the shaping frame; heating the sheet of glass material while supported by the shaping frame such that the central region of the sheet of glass material deforms into the open central cavity in a direction away from the support surface of the shaping frame, wherein an aspect of the heating experienced by the outer region of the sheet of glass material is less than an aspect of the heating experienced by the central region of the sheet of glass material; and cooling the sheet of glass material following heating to form the curved glass article from the sheet of glass material.

Aspect (2) of the present disclosure pertains to the process of Aspect (1), wherein the aspect of heating is the average temperature during the heating step and the average temperature during the heating step of the outer region of the sheet of glass material is less than the average temperature of the central region of the sheet of glass material during the heating step.

Aspect (3) of the present disclosure pertains to the process of Aspect 2, wherein the average temperature during the heating step of the outer region of the sheet of glass material is at least 30 degrees C. less than the average temperature of the central region of the sheet of glass material during the heating step.

Aspect (4) of the present disclosure pertains to the process of Aspect (2) or Aspect (3), wherein the different average temperature between the outer region and central region of the sheet of glass material during the heating step is created by conducting heat from the outer region of the sheet of glass material and into the shaping frame through the contact between the outer region of the sheet of glass material and the support surface.

Aspect (5) of the present disclosure pertains to the process of Aspect (1), wherein the aspect of heating is the heating rate during the heating step and the heating rate during the heating step of the outer region of the sheet of glass material is less than the heating rate of the central region of the sheet of glass material during the heating step.

Aspect (6) of the present disclosure pertains to the process of Aspect (1), wherein the aspect of heating is the maximum temperature during the heating step and the maximum temperature during the heating step of the outer region of the sheet of glass material is less than the maximum temperature of the central region of the sheet of glass material during the heating step.

Aspect (7) of the present disclosure pertains to the process of any one of Aspect (1) through Aspect (6), wherein the shaping frame is formed from a material having a low thermal diffusivity.

Aspect (8) of the present disclosure pertains to the process of Aspect (7), wherein the low thermal diffusivity is less than 2×10-5 m²/s.

Aspect (9) of the present disclosure pertains to the process of Aspect (7), wherein the low thermal diffusivity is less than 4×10-6 m²/s.

Aspect (10) of the present disclosure pertains to the process of any one of Aspect (1) through Aspect (9), wherein the shaping frame is formed from a wall surrounding the open central cavity, the wall including an upper surface defining the support surface, an inner surface defining the open central cavity, an outer surface opposite the inner surface and a bottom surface opposite the support surface, wherein an average width of the wall measured between the inner and outer surfaces is greater than 3 mm and an average height of the wall measured between the support surface and the bottom surface is greater than 20 mm.

Aspect (11) of the present disclosure pertains to the process of any one of Aspect (1) through Aspect (9), wherein the shaping frame is formed from a wall having an upper surface defining the support surface, an inner surface defining the open central cavity, an outer surface opposite the inner surface and a bottom surface opposite the support surface, wherein the wall has a tapered shape such that an average outer width measured across the support surface is less than an average outer width measured across the bottom surface.

Aspect (12) of the present disclosure pertains to the process of Aspect (11), wherein the wall is formed from a solid contiguous section of metal material.

Aspect (13) of the present disclosure pertains to the process of Aspect (11), wherein the wall is formed from a plurality of panels removably coupled together to form the wall.

Aspect (14) of the present disclosure pertains to the process of any one of Aspect (1) through Aspect (13), wherein gravity causes the deformation of the sheet of glass material during heating and the support surface is an upward facing surface.

Aspect (15) of the present disclosure pertains to the process of any one of Aspect (1) through Aspect (14), wherein the sheet of glass is sized to form an automobile window.

Aspect (16) of the present disclosure pertains to a system for forming a curved glass article from a sheet of glass material, the system comprising: a support ring comprising a radially inward facing inner surface defining an open central cavity, a radially outward facing surface, an upper surface surrounding the open central cavity at an upper end of the support ring, and a bottom surface opposite the upper surface, wherein the sheet of glass material is supported from the upper surface of the support ring with a central region of the sheet of glass material suspended over the open central cavity of the support ring; and a heating station having a heating chamber, the support ring located within the heating chamber and the heating station configured to heat the support ring and the sheet of glass material such that a central region of the sheet of glass material sags downward into the open central cavity under gravity; wherein the support ring is configured to conduct heat away from the sheet of glass material through the contact at the upper surface with the sheet of glass material such that an aspect of heating experienced by the portion of the sheet of glass material in contact with the upper surface of the support ring is less than an aspect of the heating experienced by the central region of the sheet of glass material.

Aspect (17) of the present disclosure pertains to the system of Aspect (16), wherein the support ring is formed from a material having a low thermal diffusivity.

Aspect (18) of the present disclosure pertains to the system of Aspect (17), wherein the low thermal diffusivity is less than 2×10-5 m²/s.

Aspect (19) of the present disclosure pertains to the system of Aspect (17), wherein the low thermal diffusivity is less than 4×10-6 m²/s.

Aspect (20) of the present disclosure pertains to the system of any one of Aspect (16) through Aspect (19), wherein an average width of the support ring measured between the radially inward facing surface and the radially outward facing surface is greater than 3 mm and an average height of the support ring measured between the upper surface and the bottom surface is greater than 20 mm.

Aspect (21) of the present disclosure pertains to the system of any one of Aspect (16) through Aspect (20), wherein the support ring has a tapered shape such that an average outer width measured across the upper surface is less than an average outer width measured across the bottom surface.

Aspect (22) of the present disclosure pertains to the system of any one of Aspect (16) through Aspect (21), wherein the support ring is formed from a solid contiguous section of metal material.

Aspect (23) of the present disclosure pertains to the system of any one of Aspect (16) through Aspect (21), wherein the support ring is formed from a plurality of panels removably coupled together to define the support ring.

Aspect (24) of the present disclosure pertains to a curved glass article made by the method(s) and/or system(s) disclosed herein, made by the method(s) of any one of Aspect (1) through Aspect (15) or made by the system of Aspect (16) through Aspect (23).

1. A process for forming a curved glass article from a sheet of glass material, the process comprising:
placing an outer region of the sheet of glass material into contact with a support surface of a shaping frame, the shaping frame defining an open central cavity surrounded at least in part by the support surface;
supporting the sheet of glass material with the shaping frame via the contact between the sheet of glass material and the support surface such that a central region of the sheet of glass material is suspended over the open central cavity of the shaping frame;
heating the sheet of glass material while supported by the shaping frame such that the central region of the sheet of glass material deforms into the open central cavity in a direction away from the support surface of the shaping frame, wherein an aspect of the heating experienced by the outer region of the sheet of glass material is less than an aspect of the heating experienced by the central region of the sheet of glass material; and
cooling the sheet of glass material following heating to form the curved glass article from the sheet of glass material.

2. The process of claim 1, wherein the aspect of heating is the average temperature during the heating step and the average temperature during the heating step of the outer region of the sheet of glass material is less than the average temperature of the central region of the sheet of glass material during the heating step.

3. The process of claim 2, wherein the average temperature during the heating step of the outer region of the sheet of glass material is at least 30 degrees C. less than the average temperature of the central region of the sheet of glass material during the heating step.

4. The process of claim 2, wherein the different average temperature between the outer region and central region of the sheet of glass material during the heating step is created by conducting heat from the outer region of the sheet of glass material and into the shaping frame through the contact between the outer region of the sheet of glass material and the support surface.

5. The process of claim 1, wherein the aspect of heating is the heating rate during the heating step and the heating rate during the heating step of the outer region of the sheet of glass material is less than the heating rate of the central region of the sheet of glass material during the heating step.

6. The process of claim 1, wherein the aspect of heating is the maximum temperature during the heating step and the maximum temperature during the heating step of the outer region of the sheet of glass material is less than the maximum temperature of the central region of the sheet of glass material during the heating step.

7. The process of claim 1, wherein the shaping frame is formed from a material having a low thermal diffusivity.

8. The process of claim 7, wherein the low thermal diffusivity is less than 2×10⁻⁵ m²/s.

9. The process of claim 7, wherein the low thermal diffusivity is less than 4×10⁻⁶ m²/s.

10. The process of claim 1, wherein the shaping frame is formed from a wall surrounding the open central cavity, the wall including an upper surface defining the support surface, an inner surface defining the open central cavity, an outer surface opposite the inner surface and a bottom surface opposite the support surface, wherein an average width of the wall measured between the inner and outer surfaces is greater than 3 mm and an average height of the wall measured between the support surface and the bottom surface is greater than 20 mm.

11. The process of claim 1, wherein the shaping frame is formed from a wall having an upper surface defining the support surface, an inner surface defining the open central cavity, an outer surface opposite the inner surface and a bottom surface opposite the support surface, wherein the wall has a tapered shape such that an average outer width measured across the support surface is less than an average outer width measured across the bottom surface.

12. The process of claim 11, wherein the wall is formed from a solid contiguous section of metal material.

13. The process of claim 11, wherein the wall is formed from a plurality of panels removably coupled together to form the wall.

14. The process of claim 1, wherein gravity causes the deformation of the sheet of glass material during heating and the support surface is an upward facing surface.

15. The process of claim 1, wherein the sheet of glass is sized to form an automobile window.

16. A system for forming a curved glass article from a sheet of glass material, the system comprising:
a support ring comprising a radially inward facing inner surface defining an open central cavity, a radially outward facing surface, an upper surface surrounding the open central cavity at an upper end of the support ring, and a bottom surface opposite the upper surface, wherein the sheet of glass material is supported from the upper surface of the support ring with a central region of the sheet of glass material suspended over the open central cavity of the support ring; and
a heating station having a heating chamber, the support ring located within the heating chamber and the heating station configured to heat the support ring and the sheet of glass material such that a central region of the sheet of glass material sags downward into the open central cavity under gravity;
wherein the support ring is configured to conduct heat away from the sheet of glass material through the contact at the upper surface with the sheet of glass material such that an aspect of heating experienced by the portion of the sheet of glass material in contact with the upper surface of the support ring is less than an aspect of the heating experienced by the central region of the sheet of glass material.

17. The system of claim 16, wherein the support ring is formed from a material having a low thermal diffusivity.

18. The system of claim 17, wherein the low thermal diffusivity is less than 2×10⁻⁵ m²/s.

19. The system of claim 17, wherein the low thermal diffusivity is less than 4×10⁻⁶ m²/s.

20. The system of claim 16, wherein an average width of the support ring measured between the radially inward facing surface and the radially outward facing surface is greater than 3 mm and an average height of the support ring measured between the upper surface and the bottom surface is greater than 20 mm.

21. The system of claim 16, wherein the support ring has a tapered shape such that an average outer width measured across the upper surface is less than an average outer width measured across the bottom surface.

22. The system of claim 16, wherein the support ring is formed from a solid contiguous section of metal material.

23. The system of claim 16, wherein the support ring is formed from a plurality of panels removably coupled together to define the support ring.

24. (canceled)
